(19) United States
(12) Patent Application Publication
(10) Pub. No.: US 2020/0030877 A1
(43) Pub. Date: Jan. 30, 2020

(54) METHOD FOR PRODUCING SILVER NANOWIRE DISPERSION LIQUID HAVING GOOD SEPARABILITY AMONG WIRES

(71) Applicant: DOWA ELECTRONICS MATERIALS CO., LTD., Tokyo (JP)

(72) Inventors: Kimitaka SATO, Tokyo (JP); Hirotoshi SAITO, Tokyo (JP); Daisuke KODAMA, Tokyo (JP)

(21) Appl. No.: 16/491,226

(22) PCT Filed: Mar. 13, 2018
(86) PCT No.: PCT/JP2018/009725

§ 371 Date: Sep. 5, 2019

(30) Foreign Application Priority Data
Mar. 14, 2017 (JP) 2017-047995

(51) Int. Cl. B22F 1/00; B01D 39/16; C09D 11/03; C09D 11/14; C09D 11/52; B22F 9/00

(52) U.S. Cl. CPC B22F 1/0044; B01D 39/1607; C09D 11/03; B82Y 40/00; C09D 11/52; B22F 9/00; B22F 2301/255; C09D 11/14

(57) ABSTRACT

A method for producing a silver nanowire dispersion liquid which exhibits good separability among wires, including: subjecting a liquid having dispersed therein silver nanowires having an average length of 10 μm or more, to at least once of filtration including filtration with an organic fiber mesh filter having an aperture of 8 μm or more and 120 μm or less, so as to provide a filtrate having dispersed therein silver nanowires having an average length of 10 μm or more (preliminary filtering step); and subjecting the filtrate obtained in the preliminary filtering step, to at least once of filtration including filtration with an organic fiber mesh filter having an aperture of 12 μm or less, so as to provide a filtrate having dispersed therein silver nanowires having an average length of 10 μm or more (finish filtering step).

### TECHNICAL FIELD

The present invention relates to a method for producing a silver nanowire dispersion liquid that is useful for forming a transparent conductor and the like.

### BACKGROUND ART

In the description herein, fine metal wires having a thickness of approximately 200 nm or less are referred to as “nanowires”. Among them, silver nanowires are expected as a conductive material for imparting conductivity to a transparent substrate. By coating a coating liquid containing silver nanowires (i.e., a silver nanowire ink) on a transparent substrate, such as glass, PET (polyethylene terephthalate), and PC (polycarbonate), followed by removing the liquid component, the silver nanowires are in contact with each other on the substrate to form a conductive network, thereby achieving a transparent conductor.

A silver nanowire generally has a structure including a linear structure formed of metallic silver having attached to the surface thereof an organic protective agent. The presence of the organic protective agent secures the dispersibility in a liquid medium, enabling the use as an ink. However, in the process of preparing an ink, organic components, such as a thickener and a binder, are added, and these components may not be homogeneously dissolved in the liquid medium, but may be present as gel-like concentrated particles (which may be hereinafter referred to as “gel-like foreign matters”) in some cases. According to the researches by the present inventors, gel-like foreign matters are often entangled with many silver nanowires, which are accumulated thereon. In the case where a coating liquid containing a large amount of the gel-like foreign matters is used for forming a conductive coated film, coarse aggregates of silver nanowires are formed in the positions where the gel-like foreign matters are present in the coated film. After patterning the conductive coated film, the coarse aggregates may form a bridge in the position where the space of the circuit is to be formed, which becomes a factor causing short-circuit of the conductor circuit. Furthermore, the coarse aggregates of silver nanowires may deteriorate the visibility (haze characteristics) of the transparent conductor. In addition, impurity particles that are not removed from but are mixed in the reaction liquid in the synthesis of silver nanowires may remain in the ink to a certain extent, and the impurity particles are also desirably removed as much as possible before applying to the coating operation.

PTL 1 describes that a silver nanowire ink is filtered with a filter before coating. The filters used include a 30 μm nylon disk filter (paragraph 0105), a 30 μm SUS disk filter (paragraph 0108), a 40 μm PP (polypropylene) cartridge filter (paragraph 0109), a 50 μm PP cartridge filter (paragraph 0110), a 50 μm PO (polyolefin) cartridge filter (paragraph 0111), and a 70 μm OP cartridge filter (paragraph 0113).

PTL 2 describes an example, in which a coating film solution containing silver nanowires is filtered through an 11 μm nylon mesh filter (paragraph 0086).

With respect to a silver nanowire dispersion liquid, a large proportion of the individual wires are dispersed in the liquid in a state separated from the other wires (the dispersed state may be hereinafter referred to as “monodispersion”). However, it is considered that a part of the wires are dispersed in the liquid to form aggregates in the form of a bundle. The possibility of the formation of the aggregates may vary depending on the attached amount of the organic protective agent and the extent of the affinity between the liquid medium and the organic protective agent. The aggregates of this type generally have a small size, and thus are difficult to remove by the filters described in the aforementioned literates, becoming a factor forming coarse aggregates of silver nanowire in coating.

### CITATION LIST

### Patent Literatures

PTL 1: JP-A-2016-66590

PTL 2: JP-A-2015-45006

### SUMMARY OF INVENTION

### Technical Problem

For preventing as much as possible the aforementioned “coarse aggregates of silver nanowires” from being present in a conductive coated film using a silver nanowire ink, the filtration of the ink before coating through a fine mesh filter is considered to be effective. However, the use of a fine mesh filter having an aperture of 10 μm or less tends to cause clogging.

Furthermore, for providing a transparent conductor that is excellent in both conductivity and visibility, it is advantageous that the average length of the silver nanowires constituting the coating liquid is as long as possible. In recent years, an ink containing silver nanowires having an average length of 10 μm or more may often be demanded. However, with the use of a filter having an aperture smaller than the average length of the wires, a large amount of the wires tend to be accumulated on the network of the filter along with the particles, such as the gel-like foreign matters, which results in concerns about the deterioration of the yield of silver and the shortening of the average length of the wire.

In view of the above, it has been said that a silver nanowire ink is difficult to filter industrially with a fine mesh filter having an aperture of 10 μm or less.

The invention is to provide a method for filtering a silver nanowire dispersion liquid through a filter having a finer mesh than an ordinary one, and particularly a technique suitable for the industrial production of a cleaned silver nanowire ink that has a small amount of impurity substance particles present therein, such as gel-like foreign matters and the like.

### Solution to Problem

According to the researches by the present inventors, it has been found that silver nanowires that have been passed through a mesh filter at least once can be smoothly passed through a finer mesh filter than the previous one, and finally can be readily passed through a filter having an aperture that is fairly smaller than the average length thereof. The filtration with such a finer filter enables the removal of impurity substance particles having a small size, which have been difficult to remove. Furthermore, the filtration through a filter having an aperture that is smaller than the average length can provide an effect that the aggregates of a part of silver nanowires entangled with each other in the form of a bundle are unraveled to enhance the separability of the individual wires. The invention has been completed based on the knowledge.

In the description herein, the following inventions are described for achieving the aforementioned objects.

[1] A method for producing a silver nanowire dispersion liquid, including:

subjecting a liquid having dispersed therein silver nanowires having an average length of 10 μm or more, to at least once of filtration including filtration with an organic fiber mesh filter having an aperture of 8 μm or more and 120 μm or less, so as to provide a filtrate having dispersed therein silver nanowires having an average length of 10 μm or more (preliminary filtering step); and

subjecting the filtrate obtained in the preliminary filtering step, to at least once of filtration including filtration with an organic fiber mesh filter having an aperture of 12 μm or less, so as to provide a filtrate having dispersed therein silver nanowires having an average length of 10 μm or more (finish filtering step).

[2] The method for producing a silver nanowire dispersion liquid according to the item [1], wherein the organic fiber mesh filter having the smallest aperture used in the preliminary filtering step has an aperture A₀ (μm), the organic fiber mesh filter having the largest aperture used in the finish filtering step has an aperture A₁ (μm), and A₀ and A₁ satisfy the following expression (1) in all the filtering steps.

A₁≥A₀/15 (1)

[3] The method for producing a silver nanowire dispersion liquid according to the item [1] or [2], wherein in the finish filtering step, the filtrate obtained in the preliminary filtering step is subjected to at least once of filtration including filtration with an organic fiber mesh filter having an aperture of 8 μm or less, so as to provide a filtrate having dispersed therein silver nanowires having an average length of 10 μm or more.

[4] The method for producing a silver nanowire dispersion liquid according to the item [1] or [2], wherein in the finish filtering step, the filtrate obtained in the preliminary filtering step is subjected to at least once of filtration including filtration with an organic fiber mesh filter having an aperture of 3 μm or less, so as to provide a filtrate having dispersed therein silver nanowires having an average length of 10 μm or more.

[5] The method for producing a silver nanowire dispersion liquid according to any one of the items [1] to [4], wherein the silver nanowire dispersion liquid subjected to the preliminary filtering step is a silver nanowire ink that contains at least one kind of HPMC (hydroxypropyl methyl cellulose) and HEMC (hydroxyethyl methyl cellulose).

[6] The method for producing a silver nanowire dispersion liquid according to any one of the items [1] to [5], wherein the silver nanowire dispersion liquid finally produced is a silver nanowire ink for die coater coating.

The organic fiber mesh filter is a filter formed of a woven fabric using organic fibers as a warp thread and a weft thread thereof. The aperture is shown by A (μm) in the following expression (1).

A=(25400/M)−d (1)

In the expression, M represents the mesh number per 25,400 μm (corresponding to 1 inch), and d represents the diameter (μm) of the organic fibers.

The “good separability among wires” means that there is a large tendency that individual silver nanowires in a silver nanowire dispersion liquid are to be dispersed in the liquid without the formation of aggregates of gathering wires (such as wire aggregates in gel-like foreign matters and aggregates formed directly from wires).

In the case where the aperture value of the organic fiber mesh filter having the smallest aperture among the filters used in all the filtering steps is 8 μm or more and 12 μm or less, the process including the final filtration that uses the organic fiber mesh filter having an aperture of 8 μm or more and 12 μm or less and the subsequent process is designated as the “finish filtering step”, and the process of filtration performed prior to that is designated as the “preliminary filtering step”. In the case where filtration using an organic fiber mesh filter having an aperture of 8 μm or less is included in all the filtering steps, the process including the first filtration that uses the organic fiber mesh filter having an aperture of 8 μm or less and the subsequent process is designated as the “finish filtering step”, and the process of filtration performed prior to that is designated as the “preliminary filtering step”.

In the description herein, the average length, the average diameter, and the average aspect ratio of the silver nanowires are in accordance with the following definitions. According to the observation by the present inventors, there is generally substantially no difference in average length and average diameter between monodispersed silver nanowires and individual silver nanowires constituting aggregates of gathering wires.

### [Average Length]

On a micrograph (such as an FE-SEM micrograph), the trace length from one end to the other end of one silver nanowire is designated as the length of the wire. The value obtained by averaging the lengths of the individual silver nanowires present on the micrograph is designated as the average length. For calculating the average length, the total number of the wires to be measured is 100 or more. A wire-like product having a length of 1.0 μm or less and a particulate product having a ratio of the length of the longest portion (which may be referred to as a “major diameter”) and the length of the longest portion in the direction perpendicular to the major diameter (which may be referred to as a “minor diameter”) (the ratio may be referred to as an “axial ratio”) of 5.0 or less are excluded from the measurement.

### [Average Diameter]

On a micrograph (such as an FE-SEM micrograph), the average width between the contours on both sides in the thickness direction of one silver nanowire is designated as the diameter of the wire. The value obtained by averaging the diameters of the respective silver nanowires present on the micrograph is designated as the average diameter. For calculating the average diameter, the total number of the wires to be measured is 100 or more. A wire-like product having a length of 1.0 μm or less and a particulate product having an axial ratio of 5.0 or less are excluded from the measurement.

### [Average Aspect Ratio]

The average aspect ratio is calculated by substituting the average diameter and the average length into the following expression (2).

(average aspect ratio)=(average length (nm))/(average diameter (nm)) (2)

### Advantageous Effects of Invention

According to the invention, a silver nanowire dispersion liquid can be smoothly filtered through a fine mesh filter having an aperture of 10 μm or less or a further smaller aperture. By applying the invention to a silver nanowire ink containing components including a thickener and a binder, not only coarse gel-like foreign matters but also considerably fine impurity substance particles can be removed. As for aggregates of silver nanowires directly entangled in the form of a bundle, an “unraveling effect” can be obtained in passing through the fine mesh filter, and the separability among the individual wires can be enhanced. Accordingly, the use of a silver nanowire dispersion liquid obtained by the invention as a coating liquid for forming a conductive coated film is expected to provide such effects as the suppression of clogging of the nozzle in coating, the prevention of short circuit in the conductive circuit formed, the enhancement of the visibility (haze property) of the transparent conductor, and the like.

### BRIEF DESCRIPTION OF DRAWINGS

FIG. 1 is the SEM micrograph of the conductive coated film obtained by using the silver nanowire ink of Comparative Example 1 (before filtering with the mesh filter) in the view field where coarse wire aggregates are found.

FIG. 2 is the SEM micrograph of the conductive coated film obtained by using the silver nanowire ink of Comparative Example 3 after the final filtration in the view field where coarse wire aggregates are found.

FIG. 3 is the SEM micrograph of the conductive coated film obtained by using the silver nanowire ink of Example 1 after the final filtration.

FIG. 4 is the SEM micrograph of the conductive coated film obtained by using the silver nanowire ink of Example 3 after the final filtration.

FIG. 5 is the SEM micrograph of the nylon mesh sheet having an aperture of 20 μm used in Comparative Example 3 and Examples 1, 2, and 3.

FIG. 6 is the SEM micrograph of the nylon mesh sheet having an aperture of 1 μm used in Example 3.

FIG. 7 is the SEM micrograph of the conductive coated film obtained by using the silver nanowire ink of Comparative Example 4 (before filtering with the mesh filter).

FIG. 8 is the SEM micrograph of the conductive coated film obtained by using the silver nanowire ink of Example 4 after the final filtration.

### DESCRIPTION OF EMBODIMENTS

[Silver Nanowire Dispersion Liquid to be subjected to Filtration]

The silver nanowire dispersion liquid to be applied to the preliminary filtering step (which may be hereinafter referred to as an “initial filtering liquid”) is a liquid having dispersed therein silver nanowires having an average length of 10 μm or more. In the preliminary filtering step and the subsequent finish filtering step, not only wires having a short length but also wires having a length of 10 μm or more are sufficiently passed through the filters. Therefore, a liquid having dispersed therein silver nanowires having an average length of 10 μm or more can be finally obtained by applying a liquid having dispersed therein silver nanowires having an average length of 10 μm or more to the initial filtering liquid. The average length of silver nanowires of the initial filtering liquid is more preferably 12 μm or more, and further preferably 15 μm or more. The average diameter thereof is preferably 50 nm or less, and wires having an average diameter of 30 nm or less may also be applied.

The silver nanowires can be synthesized by the known alcohol solvent reduction method or the like. The silver nanowires are coated with an organic protective agent. The organic protective agent secures the dispersibility in a liquid medium. For example, silver nanowires coated with PVP (polyvinylpyrrolidone) or a copolymer of vinylpyrrolidone and a hydrophilic monomer are preferred. The polymers of this kind have a vinylpyrrolidone structural unit and have good dispersibility in an aqueous medium. However, in a liquid medium having added thereto an alcohol compound having an effect of improving the wettability to a substrate, such as PET, the coating with a copolymer of vinylpyrrolidone and a hydrophilic monomer is advantageous in the improvement of the dispersibility than PVP. The hydrophilic monomer herein means a monomer that has a property that 1 g or more of the monomer is dissolved in 1,000 g of water at 25° C. Specific examples thereof include a diallyldimethylammonium salt monomer, an acrylate or methacrylate monomer, and a maleimide monomer. Examples of the acrylate or methacrylate monomer include ethyl acrylate, 2-hydroxyethyl acrylate, and 2-hydroxyethyl methacrylate. Examples of the maleimide monomer include 4-hydroxybutyl acrylate, N-methylmaleimide, N-ethylmaleimide, N-propylmaleimide, and N-tert-butylmaleimide. Silver nanowires coated with a copolymer of vinylpyrrolidine and one kind or two or more kinds of the aforementioned monomers have good dispersion retention capability in a liquid medium mainly containing water or an alcohol. The use of silver nanowires coated with the copolymer of this kind can provide a coating liquid suitable for a die coater coating in combination with HPMC or HEMC as an ink component described later.

As the liquid medium of the initial filtering liquid, a medium that has good dispersibility of the silver nanowires in the liquid may be selected depending on the purpose. Examples thereof include a water solvent, an alcohol solvent, and a mixed solvent of water and an alcohol. The content of the silver nanowires in the initial filtering liquid may be controlled to a range of from 0.01 to 5% by mass in terms of content ratio of metallic silver.

### (Silver Nanowire Ink)

In the invention, it is more effective that a silver nanowire ink having added thereto a thickener, a binder, and the like is applied to the initial filtering liquid. As the additive, such as a thickener, an organic substance soluble in the liquid medium may be basically selected, but it is not necessarily easy to dissolve completely homogeneously. Accordingly, a part of the organic substance, such as a thickener, generally remains mixed in a silver nanowire ink as gel-like foreign matters. In the gel-like foreign matters of this type, many silver nanowires are often accumulated. The foreign matters that are present in a large amount in the coating liquid may be a factor of troubles including short circuit that tends to occur in a circuit of a patterned conductive coated film due to the aggregates of silver nanowires as described above. Furthermore, the removal of the gel-like foreign matters is important from the standpoint of the enhancement of the visibility of the transparent conductor and the prevention of clogging of the nozzle in coating. The invention may provide a large effect of removing not only the coarse gel-like foreign matters but also gel-like foreign matters having a small size. Accordingly, the use of a silver nanowire ink containing an additive, such as a thickener, for the initial filtering liquid, is significantly effective for providing a highly cleaned coating liquid for a conductive coated film.

Examples of the silver nanowire ink applied to the initial filtering liquid include a silver nanowire ink containing at least one kind of HPMC (hydroxypropyl methyl cellulose) and HEMC (hydroxyethyl methyl cellulose). These organic compounds are significantly useful as a thickener for a silver nanowire ink. The HPMC used may have a weight average molecular weight, for example, in a range of from 100,000 to 1,200,000, and the HEMC used may have a weight average molecular weight, for example, in a range of from 100,000 to 1,200,000. The weight average molecular weight may be confirmed, for example, by the GPC-MALS method.

HPMC and HEMC are water soluble but are not necessarily easy to dissolve completely homogeneously in a water solvent, a mixed solvent of water and an alcohol, or the like in an industrial production process. Therefore, in a silver nanowire ink having added thereto HPMC and HEMC, the substances that are not completely dissolved generally remains as gel-like foreign matters. The total content of HPMC and HEMC in the initial filtering liquid may be, for example, from 0.01 to 1.0% by mass including the substances that are present as gel-like foreign matters.

The solvent for constituting the liquid medium of the ink is preferably any of solvents of a water solvent, an alcohol solvent, and a mixed solvent of water and an alcohol. In particular, a mixed solvent of water and an alcohol having a mass ratio of water and the alcohol of from 70/30 to 99/1 having dissolved therein HEMC is convenient for achieving both the dispersibility of the silver nanowires and the wettability to the substrate, such as PET.

The alcohol used as the solvent preferably has polarity with a solubility parameter (SP value) of 10 or more. For example, a low boiling point alcohol, such as methanol, ethanol, and isopropyl alcohol (2-propanol), may be preferably used. The SP value thereof is 23.4 for water, 14.5 for methanol, 12.7 for ethanol, and 11.5 for isopropyl alcohol.

The liquid medium may contain a binder component, in addition to the thickening component, such as HPMC and HEMC. As a material that functions as the binder without impairing the dispersibility of the nanowires and is excellent in conductivity, light transmittance, and adhesiveness, for example, at least one of a water soluble acrylic-urethane copolymer resin and a water soluble urethane resin may be contained. The total content of the water soluble acrylic-urethane copolymer resin and the water soluble urethane resin in the ink (which is the mass proportion with respect to the total mass of the ink including the silver nanowires) is preferably controlled to a range of from 0.05 to 2.0% by mass.

Examples of the binder containing a water soluble acrylic-urethane copolymer resin as a component include “UC90”, produced by Alberdingk Boley, Inc., “Adeka Bontighter HUX-401”, produced by Adeka Corporation, and “NeoPac™ E-125”, produced by DSM Coating Resins, LLC.

The binder containing a water-soluble urethane resin added is preferably a urethane resin colloid or a urethane resin dispersion. Examples thereof include Superflex 130, Superflex 150HS, Superflex 170, Superflex 210, Superflex 300, Superflex 500M, Superflex 420, Superflex 820, Superflex 12-2000, and Superflex R-5002, all produced by DSK Co., Ltd., Hydran AP-30, Hydran WLS-213, Vondic 1980NE, Hydran WLS-602, and Hydran WLS-615, all produced by DIC Corporation, Adeka Bontighter HUX-561S, Adeka Bontighter HUX-350, Adeka Bontighter HUX-282, Adeka Bontighter HUX-830, Adeka Bontighter HUX-895, Adeka Bontighter HUX-350, and Adeka Bontighter HUX-370, all produced by Adeka Corporation, NeoPac™ R-600, NeoPac™ R-650, NeoPac™ R-967, NeoPac™ R-9621, and NeoPac™ R-9330, all produced by DSM Coating Resins, LLC, Resamine D-4090, Resamine D-6065NP, Resamine D-6335NP, and Resamine D-9087, all produced by Dainichiseika Color & Chemicals Mfg. Co., Ltd., Tafigel PUR80, Tafigel PUR41, and Tafigel PUR61, all produced by Munzing Chemie GmbH, and Nostecker 400, Nostecker 1200, Evafanol HA-50C, Evafanol HA-170, Evafanol AP-12, and Evafanol APC-55, all produced by Nicca Chemical Co., Ltd.

The content of the silver nanowires in the ink is preferably controlled to a range of from 0.01 to 5.0% by mass in terms of mass ratio of metallic silver occupied in the total mass of the ink.

The silver nanowire ink preferably has a viscosity of from 1 to 100 mPa·s, and more preferably from 1 to 50 mPa·s, measured by a rotary viscometer at a shear rate of 300 (1/s), and a surface tension of from 20 to 70 mN/m, and more preferably from 30 to 60 mN/m, for providing excellent coating capability.

The viscosity may be measured, for example, with a rotation viscometer (HAAKE RheoStress 600, produced by Thermo Scientific, Inc., measurement cone: Cone C60/1° Ti, D 60 μm, plate: Meas. Plate cover MPC60).

The surface tension may be measured with a full-automatic surface tension meter (for example, a full-automatic surface tension meter, CBVP-Z, produced by Kyowa Interface Science Co., Ltd.).

### [Organic Fiber Mesh Filter]

The organic fiber mesh filter used may be a mesh sheet of a woven fabric, such as a plain woven fabric, a twill woven fabric, a plain dutch woven fabric, and a twill dutch woven fabric, formed of organic fibers as a warp thread and a weft thread thereof. The mesh sheet advantageously has flexibility to a certain extent from the standpoint of the smooth passage of the silver nanowire dispersion liquid and the prevention of damages of the wires. Examples of the organic filers include nylon, polypropylene, polyethylene, a fluorine resin, PET (polyethylene terephthalate), PET (polybutylene terephthalate), PEN (polyethylene naphthalate), and PTT (polytributylene terephthalate). A commercial product sheet specified with a value of an aperture that is produced in consideration of a filtration purpose is preferably used.

### [Filtering Method]

The organic fiber mesh filter is disposed in the midway of a pipe conduit, through which the silver nanowire dispersion liquid can flow, and the silver nanowire ink is made to flow in the pipe conduit to pass the liquid through the organic fiber mesh filter. The operation of passing the liquid through the organic mesh filter and providing a filtrate through the filter is repeated multiple times. At this time, it is advantageous that the filter is changed in sequence from one having a larger aperture to one having a smaller aperture, from the standpoint of the enhancement of the productivity in the industrial scale production. The procedure of the filtering multiple times may be a “batch system”, in which the filtrate passed through the filter is once collected, and then passed through a pipe conduit having another filter, or in alternative, a “continuous system”, in which the filtration is performed with one pipe conduit having plural filters serially provided, may be employed in a part or the entire of the filtration process. Two or more of the organic fiber mesh sheets may be used after laminating the sheets in contact with each other. In this case, it is assumed that the plural mesh sheets laminated in contact with each other constitute one mesh filter, and the aperture of the mesh filter is expressed by the aperture of one having the smallest aperture among the laminated mesh sheets.

The filtration pressure (i.e., the pressure applied to the liquid in front of the filter) is controlled to such a range that the filter and the silver nanowires are prevented from being damaged and the liquid can be smoothly passed. For example, the optimum filtration pressure may be set within a range of from 0.001 to 0.6 MPa. In the case where the filtration pressure is high, the gel-like foreign matters may be deformed and passed through the filter. Accordingly, the filtration pressure is preferably low in such a range that the liquid can be smoothly passed. With a mesh sheet having a considerably small aperture, a favorable filtering effect may be obtained with a relatively low filtration pressure. Furthermore, a measure for preventing deformation of the mesh sheet is also effective, for example, the mesh sheet is held between mesh sheets having a high strength and a larger aperture to provide a laminated structure, which is used for the filtration.

The ratio L₀/M_{MIN} of the average length L₀ (μm) of the silver nanowires in the initial silver nanowire dispersion liquid to be subjected to the preliminary filtering step (i.e., the initial filtering liquid) to the aperture M_{MIN} (μm) of the organic mesh filter having the smallest aperture used in the process of filtration is referred to as an “aperture ratio”. It is effective to perform the filtering steps described later finally with an aperture ratio in a range of from 1 to 200.

### [Preliminary Filtering Step]

Firstly, the initial filtering liquid is subjected to at least once of filtration including filtration with an organic fiber mesh filter having an aperture of 8 μm or more and 120 μm or less. Only the passage through an organic fiber mesh filter having an aperture exceeding 120 μm may be insufficient in removal of the coarse gel-like foreign matters and the like, and the smooth passage of the liquid in the finish filtering step described later may be difficult to perform. The liquid is preferably subjected to at least once of filtration including filtration with an organic fiber mesh filter having an aperture of 50 μm or less. The initial filtering liquid that contains a relatively small amount of the coarse gel-like foreign matters may be subjected to only once of filtration to complete the preliminary filtering step. According to the investigations by the inventors, it has been confirmed that with an organic fiber mesh filter having an aperture of approximately 8 μm, a filtrate having dispersed therein silver nanowires having an average length of 10 μm or more can be recovered by filtering a silver nanowire inks that has not yet been filtered through a mesh filter. However, in the case where the organic fiber mesh filter used in the initial filtration has an aperture of 8 μm or less, clogging may occur in the early stage, which is not suitable for industrial production. Accordingly, an organic fiber mesh filter having an aperture of 8 μm or more is used herein. For the initial filtering liquid that has a large amount of the coarse gel-like foreign matters, it is effective to perform filtration with an organic mesh filter having an aperture of 120 μm or more in the early stage of the preliminary filtering step.

In the case where a large amount of the initial filtering liquid is filtered in an industrial scale, it is advantageous to decrease the exchange frequency of the filter due to clogging as much as possible. It is preferred therefor that the preliminary filtering step is performed by multiple times of filtration with mesh filters having apertures that are decreased in sequence. For example, such a method may be employed that the initial filtering liquid is subjected to at least once of filtration including filtration with an organic fiber mesh filter having an aperture of 25 μm or more and 120 μm or less, and the resulting filtrate is then subjected to at least once of filtration including filtration with an organic fiber mesh filter having an aperture of 5 μm or more and 25 μm or less.

### [Finish Filtering Step]

In the filtrate having dispersed therein silver nanowires having an average length of 10 μm or more obtained by the preliminary filtering step, the coarse impurity substance particles have been mostly removed, but a large amount of impurity substance particles having a relatively small size are contained. Accordingly, the filtrate obtained in the preliminary filtering step is then filtered once or more with an organic fiber mesh filter having an aperture of 12 μm or less, and more preferably 10 μm or less. This step is referred to as the finish filtering step. The coarse impurity substance particles have been mostly removed in the preliminary filtering step, and therefore the amount of solid matters trapped by the filter may be largely decreased as compared to the case where the initial filtering liquid is passed directly through a filter having an aperture of 12 μm or less, or 10 μm or less. Accordingly, in the finish filtering step, rapid clogging can be avoided, and the liquid can be smoothly passed through the mesh filter. As a result, the filtration can be continued for a prolonged period of time while controlling the filtration pressure to a range that does not damage the filter and the silver nanowires passed therethrough, and thus long silver nanowires can be efficiently collected in the filtrate with a good yield.

In particular, the filtrate having dispersed therein silver nanowires having an average length of 10 μm can be obtained even by using a fine mesh filter having an aperture, for example, of 3 μm or less. According to the investigations by the inventors, the filtrate having dispersed therein silver nanowires having an average length of 10 μm can be obtained even by using finally a fine mesh filter having an aperture of 0.1 μm.

In view of the fact that silver nanowires having a length that is significantly larger than the aperture of the filter are collected in the filtrate, it is considered that in the filtration where the liquid is smoothly passed through the mesh filter, the wires are passed through the mesh in the longitudinal direction. According to the studies by the inventors, it has been found that the “passage in the longitudinal direction” exhibits an effect of unravelling the aggregates of gathering wires in the form of a bundle. While the details of the mechanism thereof is not clear, it is estimated that in the passage of the liquid through the mesh of the filter, the flow path is narrowed to increase the flow rate rapidly, whereas after the passage through the filter, the flow path is broadened to lower the flow rate rapidly, and therefore the portion of the wire bundle of the aggregate having been passed through the filter sequentially from the top end thereof in the longitudinal direction receives an outward external force in the thickness direction thereof by following the behavior of the surrounding liquid medium caused by the rapid broadening of the flow path and the rapid decrease of the flow rate, so as to cause the phenomenon that the individual wires are separated off from the end portion of the wire bundle of the aggregate by the external force, resulting in that the wire bundle is unraveled (i.e., pulverized into the individual wires). In the finish filtering step, accordingly, in addition to the removal of the gel-like foreign matters and the like, the pulverization of the aggregates formed of directly gathering wires (i.e., the reduction in size thereof and the separation thereof into the individual wires) can be achieved, and thus the silver nanowire dispersion liquid having good separability among the wires can be obtained. For sufficiently achieving the pulverization of the wire bundle (i.e., the unraveling effect), it is important to create a situation that the liquid is smoothly passed through the mesh filter. The smooth passage of the liquid is enabled by applying the silver nanowire dispersion liquid obtained after the preliminary filtering step to the finish filtering step.

The aforementioned unraveling effect can be obtained by subjecting the filtrate after completing the preliminary filtering step even only once to the filtration treatment with the mesh filter having an aperture in a range of 8 μm or more and 12 μm or less. For example, even in the case where the filtrate, which has been subjected to filtration with an organic fiber mesh filter having an aperture of 10 μm in the preliminary filtering step, is subjected to filtration with an organic fiber mesh filter having the same aperture of 10 μm in the finish filtering step, the smoother passage of the liquid can be achieved in the filtration in the final filtering step than in the preliminary filtering step, and thus the unraveling effect, which cannot be sufficiently achieved in the preliminary filtering step, can be enjoyed.

In order that the silver nanowires having an average length of 10 μm or more are collected in a less damaged condition with a good yield in the filtrate obtained by filtration through an organic fiber mesh filter having an aperture of 12 μm or less, preferably 10 μm or less, more preferably 8 μm or less, and further preferably 3 μm or less, and simultaneously the unraveling effect is obtained, it is necessary to pass the liquid smoothly through the mesh filter. According to the studies by the inventors, for achieving the smooth passage of the liquid in the finish filtering step, it is effective to perform the filtration under the condition where the aperture A₀ (μm) of the organic fiber mesh filter having the smallest aperture used in the preliminary filtering step and the aperture A₁ (μm) of the organic fiber mesh filter having the largest aperture used in the finish filtering step satisfy the following expression (1).

A₁≤A₀/15 (1)

The condition where the following expression (1)′ is satisfied is more preferably employed, and the condition where the following expression (1)″ is satisfied is further preferably employed.

A₁≤A₀/10 (1)′

A₁≤A₀/3 (1)″

In the finish filtering step, for achieving the smooth passage of the liquid by using finally a mesh filter having a considerably small aperture, it is effective to perform filtration multiple times by the method of decreasing the aperture of the filter in sequence. For example, such a method may be employed that the filtrate obtained in the preliminary filtering step is subjected to at least once of filtration including filtration with an organic fiber mesh filter having an aperture of 3 μm or more and 12 μm or less, and the resulting filtrate is then subjected to at least once of filtration including filtration with an organic fiber mesh filter having an aperture of 0.5 μm or more and 3 μm or less.

### [Production of Conductive Coated Film]

The silver nanowire ink having been cleaned through the second filtering step or further the third filtering step is used as a coating liquid, which is coated on a transparent substrate, such as a PET film, PC, or glass, by a die coater method or the like, and dried by removing the liquid component through vaporization or the like, so as to provide a conductive coated film. A transparent conductive circuit can be obtained by pattering the conductive coated film by such a method as laser etching or a combination of a resist and wet development. The use of the coating liquid having been cleaned according to the invention can significantly suppress the troubles including short circuit caused by the silver nanowire aggregates in the transparent conductive circuit having fine lines and spaces.

### EXAMPLES

### Synthesis of Silver Nanowires

At ordinary temperature, 0.484 g of lithium chloride, 0.1037 g of potassium bromide, 0.426 g of lithium hydroxide, 4.994 g of a propylene glycol solution having a content of aluminum nitrate nonahydrate of 20% by mass, and 83.875 g of a copolymer of vinylpyrrolidone and diallyldimethylammonium nitrate were added and dissolved in 7,800 g of propylene glycol to provide a solution A. In a separate vessel, 67.96 g of silver nitrate was added to 320 g of propylene glycol and dissolved therein by agitating at room temperature, so as to provide a solution B containing silver.

The solution A was placed in a reaction vessel and heated from ordinary temperature to 90° C. under agitation, and then the entire amount of the solution B was added to the solution A over 1 minute. After completing the addition of the solution B, the agitation state was further retained, and the temperature was retained to 90° C. for 24 hours. Thereafter, the reaction liquid was cooled to ordinary temperature. Silver nanowires were synthesized in this manner by the synthesis method utilizing the reduction power of the alcohol solvent (alcohol solvent reduction method).

### [Washing]

1 L of the reaction liquid (i.e., the liquid containing the synthesized silver nanowires) cooled to ordinary temperature was collected and transferred to a PFA bottle having a capacity of 35 L, and 20 kg of acetone was added thereto, followed by agitating for 15 minutes. Thereafter, the mixture was allowed to stand for 24 hours. After allowing to stand, while a concentrate and a supernatant were observed, the supernatant was removed, and the concentrate was recovered. An appropriate amount of a PVP aqueous solution of 1% by mass was added to the resulting concentrate, and after agitating 3 hours, it was confirmed that the silver nanowires were redispersed. After agitation, 2 kg of acetone was added thereto, and the mixture was agitated for 10 minutes and then allowed to stand. After allowing to stand, while a concentrate and a supernatant were again observed, the supernatant was removed, and the concentrate was recovered. 160 g of pure water was added to the resulting concentrate, and the silver nanowires were redispersed therein. 2 kg of acetone was added to the silver nanowire dispersion liquid after redispersing, and the mixture was agitated for 30 minutes and then allowed to stand. After allowing to stand, while a concentrate and a supernatant were again observed, the supernatant was removed, and the concentrate was recovered. An appropriate amount of a PVP aqueous solution of 0.5% by mass was added to the resulting concentrate, and the mixture was agitated for 12 hours. In this washing step, silver nanoparticles and short silver nanowires as by-products are removed in the supernatant to some extent since these are hard to undergo sedimentation. However, nanowires having a length of 5 μm or less, which have less contribution to conductivity in a transparent conductor and tend to be a factor causing haze therein, are difficult to remove by the method of repeating agglomeration and dispersion. Accordingly, the following crossflow filtration shown below was performed as a method of extracting wires having a large average length.

### [Crossflow Filtration]

The silver nanowire dispersion liquid obtained through the aforementioned washing was diluted with pure water to a silver nanowire concentration of 0.07% by mass, and subjected to crossflow filtration by using a tube of a porous ceramic filter. The crossflow filtration was performed by a circulating system, in which the liquid in a tank was returned through a pump and a filtering device to the tank. The material of the filter was SiC (silicon carbide), and the tube had an outer diameter of 12 μm, an inner diameter of 9 μm, and a length of 500 μm. The filter had an average pore diameter (median diameter) of 5.9 μm measured by the mercury intrusion method using a mercury porosimeter, produced by Micromeritics Instrument Corporation. In the crossflow filtration, wires having a larger length tend to flow in the tube and remain in the circulated liquid without discharge as a filtrate outside the system through the tube wall of the ceramic filter. Wires having a large average length are recovered by utilizing the filtering characteristics. Accordingly, in the crossflow filtration, the filtrate is to be removed, but the liquid flowing in the tube is to be recovered, as being different from the filtration with a mesh filter.

A silver nanowire dispersion liquid having a concentration of 0.07% by mass was prepared to make a liquid amount in the entire circulation system of 52 L. The silver nanowire dispersion liquid was circulated at a flow rate of 150 L/min for 12 hours while replenishing pure water in an amount equivalent to the amount of the liquid discharged as the filtrate. Thereafter, the crossflow filtration was continued for 12 hours in a state where no pure water was replenished, and thereby the silver nanowire dispersion liquid was concentrated by utilizing the phenomenon that the filtrate was discharged to decrease the liquid amount gradually.

A small amount of a specimen was collected from the silver nanowire dispersion liquid after the crossflow filtration, and after evaporating water as the dispersion medium on an observation table, observed with FE-SEM (high resolution field emission scanning electron microscope), and as a result, the silver nanowires had an average length of 17.6 μm, an average diameter of 26.4 nm, and an average aspect ratio of 17,600/26.4≈667.

The measurement of the diameter was performed with SEM micrographs taken by using a high resolution FE-SEM (field emission scanning electron microscope, S-4700, produced by Hitachi, Ltd.) in an ultra-high resolution mode, at a focal length of 7 μm, an acceleration voltage of 20 kV, and a magnification of 150,000, and the measurement of the length was performed with SEM micrographs taken thereby in a normal mode, at a focal length of 12 μm, an acceleration voltage of 3 kV, and a magnification of 2,500 (the same as in the following examples).

### [Production of HEMC-Containing Silver Nanowire Ink]

### Comparative Example 1

HEMC having a weight average molecular weight of 910,000 (hydroxyethyl methyl cellulose, produced by Tomoe Engineering Co., Ltd.) was prepared. Powder of HEMC was placed in hot water at 99° C. under strong agitation with an agitator, which was then strongly agitated continuously for 24 hours, and then cooled to 10° C. The cooled liquid was filtered with a metal mesh having an aperture of 100 μm to remove the jelly-like insoluble component, so as to provide an aqueous solution having dissolved therein HEMC.

An emulsion of a water soluble acrylic-urethane copolymer resin (NeoPac™ E-125, produced by DSM Coating Resins, LLC.) was prepared as a binder.

In one vessel with a lid, the silver nanowire dispersion liquid (containing water as a medium) obtained by the aforementioned crossflow filtration, the HEMC aqueous solution, the water soluble acrylic-urethane copolymer resin emulsion, and 2-propanol (isopropyl alcohol) were placed, and after closing the lid, were mixed by agitation by a method of shaking the vessel vertically 100 times per minute in a stroke length of from 10 to 20 cm.

A silver nanowire ink was thus obtained in this manner that had an ink composition containing 20% by mass of 2-propanol, 0.30% by mass of HEMC, 0.15% by mass of the binder component, and 0.15% by mass of the silver nanowires (including silver and the organic protective agent), with the balance of water.

10 mL of a specimen liquid was collected from the HEMC-containing silver nanowire ink obtained above, and measured for the number of particulate matters in the specimen liquid with a liquid-borne particle counter (KS-42D, produced by Rion Co., Ltd.). The measurement of the number of particles with the liquid-borne particle counter was performed with a liquid having a silver nanowire concentration of 0.001% by mass prepared by diluting the specimen liquid with pure water.

The number of particulate matters measured by the method is considered to be gel-like foreign matters that are mainly derived from the thickening component (HEMC) and the binder component present in the ink. The particles having a particle diameter exceeding 10 μm counted by the measurement tend to cause clogging of the nozzle in die coater coating, and the silver nanowires accumulated in the particles tend to cause short circuit of a transparent conductive circuit. In the case where particles having a particle diameter exceeding 5 μm are present in a large amount, the possibility of occurrence of short circuit in a transparent conductive circuit having fine lines due to the silver nanowires aggregated in the particles is increased, even though the particles have a particle diameter of 10 μm or less. In the description herein, for the filtrate obtained in this comparative example (i.e., the initial filtering liquid, which is to be subjected to filtration with an organic fiber mesh filter) and the filtrates obtained in Comparative Examples 2 and 3 and Examples 1 to 3 described later, the numbers of particulate matters having a particle diameter exceeding 10 μm and particulate matters having a particle diameter exceeding 5 μm measured with the particle counter are exemplified in Table 1.

[Filtration of HEMC-Containing Silver Nanowire Ink with Organic Fiber Mesh Filter]

### Comparative Example 2

The silver nanowire ink obtained in Comparative Example 1 was used as an initial filtering liquid applied to the first filtering step.

One sheet of a nylon mesh sheet (produced by Clever Co., Ltd.), which was a synthetic fiber mesh (nylon mesh bolting cloth) having an aperture of 30 μm woven with nylon monofilaments was disposed in the midway of a pipe conduit constituted by a stainless steel pipe having an inner diameter of 8 μm, so as to constitute a filtering device. The filter constituted by the nylon mesh sheet had a liquid passage area having a diameter of 8 μm. 20 L of the initial filtering liquid was passed through the pipe conduit to perform filtration, and the filtrate was recovered. A pressurizing force was applied to the liquid with nitrogen gas to make a filtration pressure (i.e., a pressure applied to the front of the filter) of 0.2 MPa. The smooth passage of the liquid was achieved while retaining the filtration pressure until completing the filtration of the entire amount of the liquid. 10 mL of a specimen liquid was collected from the filtrate and measured for the number of particulate matters in the specimen liquid with the liquid-borne particle counter in the same manner as above. The aperture ratio in the stage where Comparative Example 2 was completed was 17.6/30≈0.59.

### Comparative Example 3

Subsequently, the filter of the filtering device was replaced by a filter constituted by one sheet of a nylon mesh sheet (produced by Clever Co., Ltd.), which was a synthetic fiber mesh (nylon mesh bolting cloth) having an aperture of 20 μm woven with nylon monofilaments, and the filtrate recovered in the filtration in Comparative Example 2 was filtered at a filtration pressure of 0.2 MPa in the same manner as above, followed by collecting the filtrate. The smooth passage of the liquid was achieved while retaining the filtration pressure until completing the filtration of the entire amount of the liquid. 10 mL of a specimen liquid was collected from the filtrate and measured for the number of particulate matters in the specimen liquid with the liquid-borne particle counter in the same manner as above. The aperture ratio in the stage where Comparative Example 3 was completed was 17.6/20≈0.88.

### Example 1

Subsequently, the filter of the filtering device was replaced by a filter constituted by one sheet of a nylon mesh sheet (produced by Clever Co., Ltd.), which was a synthetic fiber mesh (nylon mesh bolting cloth) having an aperture of 10 μm woven with nylon monofilaments, and the filtrate recovered in the filtration in Comparative Example 3 was filtered at a filtration pressure of 0.2 MPa in the same manner as above, followed by collecting the filtrate. The smooth passage of the liquid was achieved while retaining the filtration pressure until completing the filtration of the entire amount of the liquid. 10 mL of a specimen liquid was collected from the filtrate and measured for the number of particulate matters in the specimen liquid with the liquid-borne particle counter in the same manner as above. The aperture ratio in the stage where Example 1 was completed was 17.6/10≈1.76. In Example 1, the filtration with the filter having an aperture of 30 μm used in Comparative Example 2 and the filtration with the filter having an aperture of 20 μm used in Comparative Example 3 correspond to the “preliminary filtering step”, and the aforementioned filtration with the filter having an aperture of 10 μm corresponds to the “finish filtering step”.

### Example 2

Subsequently, the filter of the filtering device was replaced by a filter constituted by one sheet of a nylon mesh sheet (produced by Clever Co., Ltd.), which was a synthetic fiber mesh (nylon mesh bolting cloth) having a thickness of 100 μm and an aperture of 5 μm woven with nylon monofilaments, and the filtrate recovered in the filtration in Example 1 was filtered at a filtration pressure of 0.2 MPa in the same manner as above, followed by collecting the filtrate. The smooth passage of the liquid was achieved while retaining the filtration pressure until completing the filtration of the entire amount of the liquid. 10 mL of a specimen liquid was collected from the filtrate and measured for the number of particulate matters in the specimen liquid with the liquid-borne particle counter in the same manner as above. The aperture ratio in the stage where Example 2 was completed was 17.6/5≈3.52. In Example 2, the filtration with the filter having an aperture of 30 μm used in Comparative Example 2, the filtration with the filter having an aperture of 20 μm used in Comparative Example 3, and the filtration with the filter having an aperture of 10 μm used in Example 1 correspond to the “preliminary filtering step”, and the aforementioned filtration with the filter having an aperture of 5 μm corresponds to the “finish filtering step”.

### Example 3

Subsequently, the filter of the filtering device was replaced by a filter constituted by two sheets of nylon mesh sheets (produced by Clever Co., Ltd.) laminated on each other, each of which was a synthetic fiber mesh (nylon mesh bolting cloth) having a thickness of 75 μm and an aperture of 1 μm woven with nylon monofilaments, and the filtrate recovered in the filtration in Example 2 was filtered at a filtration pressure of 0.05 MPa in the same manner as above, followed by collecting the filtrate (referred to as a “1 μm mesh passed filtrate”). The smooth passage of the liquid was achieved while retaining the filtration pressure until completing the filtration of the entire amount of the liquid.

Subsequently, the filter of the filtering device was replaced by a filter having a so-called sandwich structure (assumed to have an aperture of 0.1 μm) obtained by laminating three sheets including a nylon mesh sheet (produced by Clever Co., Ltd.), which was a synthetic fiber mesh (nylon mesh bolting cloth) having an aperture of 0.1 μm woven with nylon monofilaments, held between two sheets of nylon mesh sheets having an aperture of 1 μm, and the “1 μm mesh passed filtrate” was filtered at a filtration pressure of 0.005 MPa in the same manner as above, followed by collecting the filtrate. The smooth passage of the liquid was achieved while retaining the filtration pressure until completing the filtration of the entire amount of the liquid. 10 mL of a specimen liquid was collected from the filtrate and measured for the number of particulate matters in the specimen liquid with the liquid-borne particle counter in the same manner as above. The aperture ratio in the stage where Example 3 was completed was 17.6/0.1≈176. In Example 3, the filtration with the filter having an aperture of 30 μm used in Comparative Example 2, the filtration with the filter having an aperture of 20 μm used in Comparative Example 3, and the filtration with the filter having an aperture of 10 μm used in Example 1 correspond to the “preliminary filtering step”, and the filtration with the filter having an aperture of 5 μm used in Example 2, the aforementioned filtration with the filter having an aperture of 1 μm, and the aforementioned filtration with the filter having an aperture of 0.1 μm correspond to the “finish filtering step”.

The silver nanowire ink having been cleaned by performing the filtration to this stage was measured for the average length of the silver nanowires, and the result thereof was 18.4 μm. It was confirmed that the silver nanowires having an average length of 10 μm or more were able to be recovered even with the use of the mesh filter having a considerably fine mesh with an aperture of 0.1 μm.

TABLE 1

| | | | | Number of particles measured by | |
|---|---|---|---|---|---|
| | | | | particle counter (/10 mL) | |
| | | | Filtering | Particle | Particle |
| | | | pressure | diameter > | diameter > |
| Example No. | Filtering step | Filter | (MPa) | 5 μm | 10 μm |
| Comparative | (before filtration) | — | — | 2214 | 579 |
| Example 1 | | | | | |
| Comparative | Preliminary filtering step | nylon mesh 30 μm | 0.2 | 2341 | 532 |
| Example 2 | | | | | |
| Comparative | Preliminary filtering step | nylon mesh 30 μm | 0.2 | 2184 | 382 |
| Example 3 | | | | | |
| | | → nylon mesh 20 μm | → 0.2 | | |
| Example 1 | Preliminary filtering step | nylon mesh 30 μm | 0.2 | 1755 | 288 |
| | | → nylon mesh 20 μm | → 0.2 | | |
| | Finish filtering step | → nylon mesh 10 μm | → 0.2 | | |
| Example 2 | Preliminary filtering step | nylon mesh 30 μm | 0.2 | 1540 | 222 |
| | | → nylon mesh 20 μm | → 0.2 | | |
| | | → nylon mesh 10 μm | → 0.2 | | |
| | Finish filtering step | → nylon mesh 5 μm | → 0.2 | | |
| Example 3 | Preliminary filtering step | nylon mesh 30 μm | 0.2 | 1107 | 212 |
| | | → nylon mesh 20 μm | → 0.2 | | |
| | | → nylon mesh 10 μm | → 0.2 | | |
| | Finish filtering step | → nylon mesh 5 μm | → 0.2 | | |
| | | → nylon mesh 1 μm + 1 μm | → 0.05 | | |
| | | → nylon mesh 1 μm + 0.1 μm + 1 μm | → 0.05 | | |

It was understood from Table 1 that the decreasing effect of particulate matters having a particle diameter exceeding 10 μm was found by the filtration corresponding to the preliminary filtering step (Comparative Examples 2 and 3), but significant decrease thereof was found in the case where the filtrate after completing the preliminary filtering step was subjected to the finish filtering step (Examples 1 and 2).

For the number of particulate matters having a particle diameter exceeding 5 μm (including the number of particulate matters having a particle diameter exceeding 10 μm), a large decreasing effect was not found in the stage of the filtration corresponding to the preliminary filtering step (Comparative Examples 2 and 3), but significant decrease thereof was found in the case where the finish filtering step was performed (Examples 1 and 2). In particular, the filtration through the considerably fine mesh filter was finally enabled by passing through the mesh filters having apertures decreased in sequence, and the excellent decreasing effect was obtained for small particulate matters having a particle diameter of from 5 to 10 μm (Example 3).

### [Production of HPMC-Containing Silver Nanowire Ink]

### Comparative Example 4

HPMC having a weight average molecular weight of 660,000 (hydroxypropyl methyl cellulose, 90SH-30000, produced by Shin-Etsu Chemical Co., Ltd.) was prepared. Powder of HPMC was placed in hot water under strong agitation with an agitator, which was then spontaneously cooled to 40° C. under continuous strong agitation, and then cooled to 10° C. or less with a chiller. The cooled liquid was filtered with a metal mesh having an aperture of 100 μm to remove the jelly-like insoluble component, so as to provide an aqueous solution having dissolved therein HPMC.

A urethane resin dispersion (Resamine D-4090, produced by Dainichiseika Color & Chemicals Mfg. Co., Ltd.) was prepared as a binder.

In one vessel with a lid, the silver nanowire dispersion liquid (containing water as a medium) obtained by the aforementioned crossflow filtration, the HPMC aqueous solution, the urethane resin dispersion, and isopropyl alcohol were placed, and after closing the lid, were mixed by agitation by a method of shaking the vessel vertically 100 times per minute in a stroke length of from 10 to 20 cm.

A silver nanowire ink was thus obtained in this manner that had an ink composition containing 10% by mass of 2-propanol, 0.175% by mass of HPMC, 0.133% by mass of the binder component, and 0.2% by mass of the silver nanowires (including silver and the organic protective agent), with the balance of water.

10 mL of a specimen liquid was collected from the HPMC-containing silver nanowire ink obtained above, and measured for the number of particulate matters in the specimen liquid with a liquid-borne particle counter (KS-42D, produced by Rion Co., Ltd.) in the same manner as in Comparative Example 1.

[Filtration of HPMC-Containing Silver Nanowire Ink with Organic Fiber Mesh Filter]

### Example 4

The silver nanowire ink obtained in Comparative Example 4 was used as an initial filtering liquid applied to the first filtering step, and the filtration with the organic fiber mesh filters in the same manner as in Example 3. The liquid after the filtration was measured for the number of particulate matters with the liquid-borne particle counter in the same manner as in Comparative Example 1.

The results are shown in Table 2.

TABLE 2

| | | | | Number of particles measured by | |
|---|---|---|---|---|---|
| | | | | particle counter (/10 mL) | |
| | | | Filtering | Particle | Particle |
| | | | pressure | diameter > | diameter > |
| Example No. | Filtering step | Filter | (MPa) | 5 μm | 10 μm |
| Comparative | (before filtration) | — | — | 1838 | 582 |
| Example 4 | | | | | |
| Example 4 | Preliminary filtering step | nylon mesh 30 μm | 0.2 | 847 | 209 |
| | | → nylon mesh 20 μm | → 0.2 | | |
| | | → nylon mesh 10 μm | → 0.2 | | |
| | Finish filtering step | → nylon mesh 5 μm | → 0.2 | | |
| | | → nylon mesh 1 μm + 1 μm | → 0.05 | | |
| | | → nylon mesh 1 μm + 0.1 μm + 1 μm | → 0.05 | | |

It was understood from Table 2 that as for the silver nanowire ink using HPMC as the thickening component, the filtration through the considerably fine mesh filter was finally enabled by passing through the mesh filters having apertures decreased in sequence, and the excellent decreasing effect was obtained for small particulate matters having a particle diameter of from 5 to 10 μm.

### [Production of Conductive Coated Film]

Conductive coated films were produced by using the silver nanowire inks in Comparative Examples 1 and 4 (i.e., the initial filtering liquids before filtration) and the silver nanowire inks after completing the filtration in Comparative Examples 2 and 3 and Examples 1, 2, 3, and 4 according to the following manner.

The silver nanowire ink was coated on a surface of a PET film substrate (Lumirror U48, produced by Toray Industries, Inc.) having a thickness of 100 μm and a dimension of 150 μm×200 μm with a die coater (New Taku-Die S-100, produced by Die Gage Corporation), so as to form a coated film having an area of 100 μm×100 μm. The coating conditions were as follows: wet thickness: 11 μm, gap: 21 μm, speed: 10 μm/s, timer: 2.2 s, and coating length: 100 mm. After coating, the coated film was dried at 120° C. for 1 minute to provide a transparent conductive coated film.

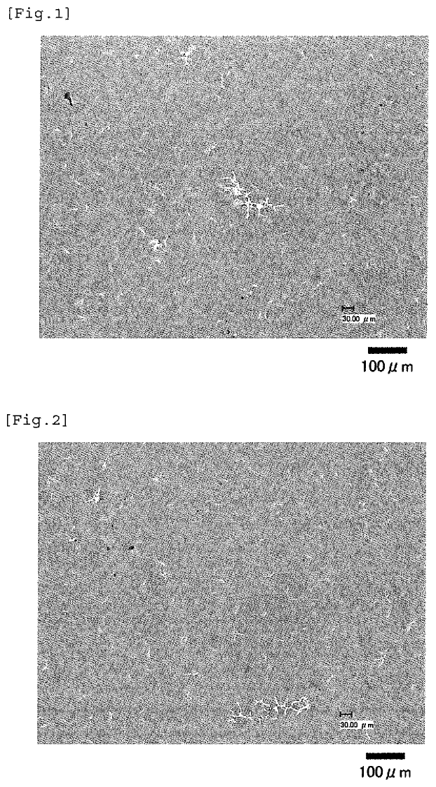

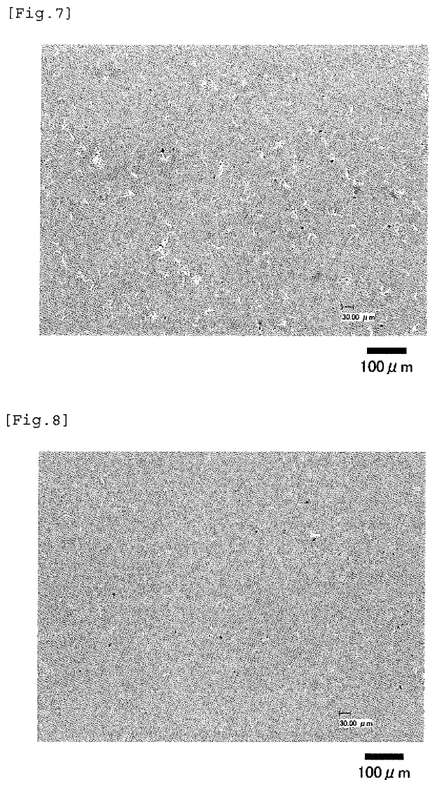

The conductive coated film was observed with SEM (scanning electron microscope). As a result, in the coated films using the inks of Comparative Examples 1 and 4 (initial filtering liquids), “wire aggregates” formed by further aggregating silver nanowire aggregates in the form of a bundle were found in many positions. It is considered that the coarse wire aggregates of this type are derived from the gel-like foreign matters formed mainly of the thickening component. FIG. 1 shows the SEM micrograph of the conductive coated film obtained by using the silver nanowire ink of Comparative Example 1 (before filtering with the mesh filter) in the view field where the coarse wire aggregates are found. The aggregates of matters that looked white at the center correspond to the coarse wire aggregates. FIG. 7 shows the SEM micrograph of the conductive coated film obtained by using the silver nanowire ink of Comparative Example 4 (before filtering with the mesh filter). Many wire aggregates are found in this example.

The coarse wire aggregates were also found in the conductive coated films obtained by using the filtrates of Comparative Example 2 and Comparative Example 3 having been subjected to the filtration corresponding to the preliminary filtering step. However, in the observation of many view fields, the frequency of occurrence of the coarse wire aggregates was smaller in Comparative Example 2 than in Comparative Example 1, and was further smaller in Comparative Example 3. FIG. 2 shows the SEM micrograph of the conductive coated film obtained by using the ink of Comparative Example 3 after the final filtration in the view field where the coarse wire aggregates are found. The coarse wire aggregates are found in the lower part and the like of the micrograph.

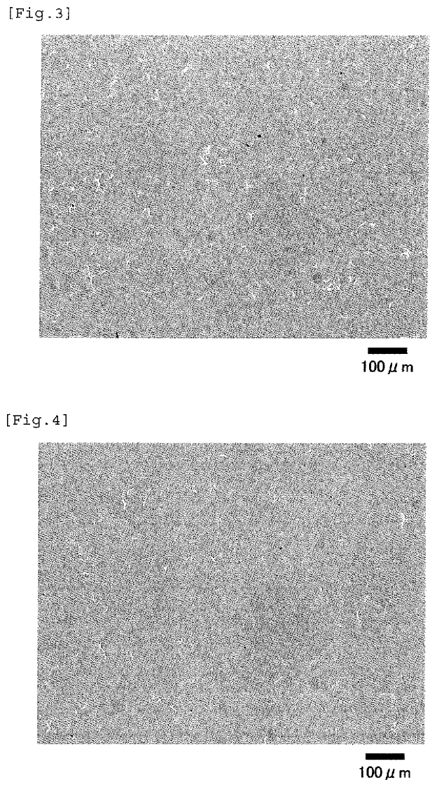

In the conductive coated films obtained by using the filtrates of Examples 1 and 2 having been subjected to the finish filtering step, there was a small tendency that aggregates of gathering wires in the form of a bundle were accumulated, and the coarse wire aggregates as shown in FIGS. 1 and 2 were substantially not found. FIG. 3 shows the SEM micrograph of the conductive coated film obtained by using the ink of Example 1 after the filtration.

In the conductive coated film obtained by using the filtrate of Example 3, the tendency that aggregates of gathering wires in the form of a bundle were accumulated was smaller than Examples 1 and 2, and the amount of the aggregates of wires in the form of a bundle was also decreased. It is considered that the aforementioned “unraveling effect” was more significantly exhibited in the passage of the wire bundles through the fine mesh in the longitudinal direction. FIG. 4 exemplifies the SEM micrograph of the conductive coated film obtained by using the ink of Example 3 after the filtration. FIG. 8 exemplifies the SEM micrograph of the conductive coated film obtained by using the ink of Example 4 after the filtration. The tendency that aggregates of gathering wires in the form of a bundle were accumulated was small also in Example 4. The amount of the aggregates of wires in the form of a bundle was significantly decreased as compared to Comparative Example 4 (i.e., the comparison between FIG. 7 and FIG. 8), which was considered to be caused by the exhibition of the “unraveling effect”.

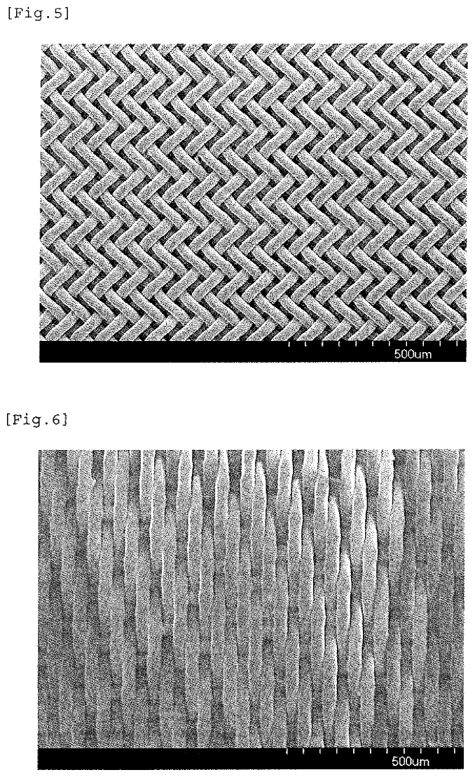

FIG. 5 shows the SEM micrograph of the nylon mesh sheet having an aperture of 20 μm used in Comparative Example 3 and Examples 1, 2, and 3. FIG. 6 shows the SEM micrograph of the nylon mesh sheet having an aperture of 1 μm used in Example 3. In each of the micrographs, the distance between the left end and the right end of the 11 scale lines in the right lower portion of the micrograph corresponds to the length (μm) of the value shown thereunder. The weaves of the nylon mesh sheets used in the examples other than these sheets are the same as these sheets.

1. A method for producing a silver nanowire dispersion liquid, comprising:
subjecting a liquid having dispersed therein silver nanowires having an average length of 10 μm or more, to at least once of filtration including filtration with an organic fiber mesh filter having an aperture of 8 μm or more and 120 μm or less, so as to provide a filtrate having dispersed therein silver nanowires having an average length of 10 μm or more (preliminary filtering step); and
subjecting the filtrate obtained in the preliminary filtering step, to at least once of filtration including filtration with an organic fiber mesh filter having an aperture of 12 μm or less, so as to provide a filtrate having dispersed therein silver nanowires having an average length of 10 μm or more (finish filtering step).

2. The method for producing a silver nanowire dispersion liquid according to claim 1, wherein the organic fiber mesh filter having the smallest aperture used in the preliminary filtering step has an aperture A₀ (μm), the organic fiber mesh filter having the largest aperture used in the finish filtering step has an aperture A₁ (μm), and A₀ and A₁ satisfy the following expression (1) in all the filtering steps:
A₁≤A₀/15 (1)

3. The method for producing a silver nanowire dispersion liquid according to claim 1, wherein in the finish filtering step, the filtrate obtained in the preliminary filtering step is subjected to at least once of filtration including filtration with an organic fiber mesh filter having an aperture of 8 μm or less, so as to provide a filtrate having dispersed therein silver nanowires having an average length of 10 μm or more.

4. The method for producing a silver nanowire dispersion liquid according to claim 1, wherein in the finish filtering step, the filtrate obtained in the preliminary filtering step is subjected to at least once of filtration including filtration with an organic fiber mesh filter having an aperture of 3 μm or less, so as to provide a filtrate having dispersed therein silver nanowires having an average length of 10 μm or more.

5. The method for producing a silver nanowire dispersion liquid according to claim 1, wherein the silver nanowire dispersion liquid subjected to the preliminary filtering step is a silver nanowire ink that contains at least one kind of HPMC (hydroxypropyl methyl cellulose) and HEMC (hydroxyethyl methyl cellulose).

6. The method for producing a silver nanowire dispersion liquid according to claim 1, wherein the silver nanowire dispersion liquid finally produced is a silver nanowire ink for die coater coating.
